(19) United States
(12) Patent Application Publication
(10) Pub. No.: US 2007/0248294 A1
(43) Pub. Date: Oct. 25, 2007

(54) Bearing Housing for a Conveyor Assembly and Bearing Assembly System

(76) Inventor: Todd Gerald Jager, Sioux City, IA (US)

Correspondence Address: DORSEY & WHITNEY LLP;INTELLECTUAL PROPERTY DEPARTMENT, 801 GRAND, SUITE 3900, DES MOINES, IA, 50309, US

(21) Appl. No.: 11/379,438

(22) Filed: Apr. 20, 2006

(51) Int. Cl. F16C 33/02

(52) U.S. Cl. 384/295

(57) ABSTRACT

An easy to clean, assemble and disassemble bearing assembly is provided. The assembly comprises a bearing housing for removably securing a bearing in a conveyor assembly. The bearing housing comprises a means for attaching same to a conveyor assembly without fasteners and a means for attaching a bearing within the bearing housing without fasteners. A bearing assembly having a bearing housing attached to a panel, a bearing, and a shaft, as well as a method of assembling a bearing assembly are also disclosed.

### FIELD OF INVENTION

The bearing housing for a conveyor and bearing assembly system disclosed relate to bearing retention mechanisms and conveyor assemblies having a means for retaining a bearing.

### BACKGROUND

Conveyor systems are well known in the art and often comprise belts, rollers, drive systems, side rails or panels, support systems and so forth. Generally, a conveyor assembly comprises one or more bearings; a bed upon which materials to be conveyed are placed; a belt that wraps around a conveyor pulley which transmits motion necessary for the movement of materials between two points; a drive and a drive pulley (when a power conveyor is used); a frame that provides the structural conveyor system support for the machinery that makes up the conveyor system; a pulley or wheel mechanism that controls movement, speed, and the direction of conveyed materials; wear strips; and so forth.

Conveyor assemblies have been used for some time in various industries as a means of distribution for materials in manufacturing and processing of different products, ranging from boxes, to pharmaceuticals, to food products, to toys and many other products. For instance, in the food industry, it is common for conveyors to be used for the transport of products such as, but not limited to, produce, meats, and other dry goods between various processing stations within a food processing facility. In view of same, sanitation is a primary consideration in the food processing industry. Many such conveyor systems, such as those used in the food processing industry, must be capable of being easily assembled, disassembled and cleaned. Conveyors must be maintained in a clean and hygienic condition to meet basic sanitary conditions. Cleaning of the conveyors is extremely costly as it requires the repeated outlay of money for soap, water and other chemicals, as well as down time of the machines, and staff or cleaning crews to maintain a rigorous cleaning schedule. Much of the cost associated with maintaining clean, sanitary conveyors is that current conveyor systems have numerous cracks, corners, screw holes, flat surfaces and other crevices where water, bacteria, mold, food waste and unwanted materials can collect. In order to reach these areas, conveyor assemblies require the disassembly of various components, and may in fact include areas that are difficult, if not impossible, to access. In many instances, including the fastening of bearings to the conveyor assembly, fastening devices, such as screws, bolts, clamps and the like are used to connect various components of the conveyor assembly. These interfaces between the fastening means and the holes that are required for same, define environments where bacteria and dirt can easily collect or bacteria may grow. Further, these areas are difficult to clean. Thus, conveyor assemblies that are currently available and their components are often difficult to clean, sterilize and maintain due to the numerous components that are attached together and the number of components that provide spaces for water and waste to collect and bacteria to grow.

As indicated, conveyor assemblies often require bearings to facilitate the movement of certain movable components, such as shafts, rollers and the like. Unfortunately, current systems require the bearing to be attached to the conveyor system using conventional fasteners, such as threaded fasteners or screws, clamps, and the like. In some instances certain components must be welded together. The problem with such fastening mechanisms is that either the bearing cannot be removed or the fastener system is difficult to clean and requires significant down time of the conveyor for assembly and disassembly.

Accordingly, what is needed in the art is a system for removably securing a bearing or the like within a conveyor assembly which is easy to assemble, and disassemble, and easy to clean.

### SUMMARY OF THE INVENTION

To this end, a bearing housing for removably securing a bearing in a conveyor assembly is provided. The bearing housing comprises a means for attaching same to a conveyor assembly without the use of fasteners and a means for attaching a bearing within the bearing housing without the use of fasteners. As a result, the bearing housing, and therefore the bearing, are easily removed and/or assembled, and easy to clean.

Accordingly, the bearing housing for a conveyor assembly and bearing assembly system disclosed provide a assembly that is easy to clean and maintain in a sanitary state. Furthermore, the bearing assembly is easy to disassemble and assemble.

Other aspects, features and details of the present invention can be more completely understood by reference to the following detailed description in conjunction with the drawings, and from the appended claims.

### BRIEF DESCRIPTION OF THE DRAWINGS

The invention will now be described, by way of example, with reference to the attached drawings, of which:

FIG. 1 is a perspective view of a bearing housing of an embodiment of the present invention from a first side thereof.

FIG. 2 is a perspective view of the bearing housing of FIG. 1 from a second side thereof.

FIG. 3 is an elevational view of the first side of the bearing housing shown in FIG. 1.

FIG. 4 is an elevational view of the second side of the bearing housing shown in FIG. 2.

FIG. 5 is a plan view of the bearing housing of FIG. 1.

FIG. 6 is an end elevational view of the bearing housing of FIG. 1 from a first end thereof.

FIG. 7 is an end elevational view of the bearing housing of FIG. 1 from a second end thereof.

FIG. 8 is a perspective view of a cap as used in an embodiment of the bearing housing of the present invention.

FIG. 9 is a perspective view of the cap of FIG. 8 from an underside thereof.

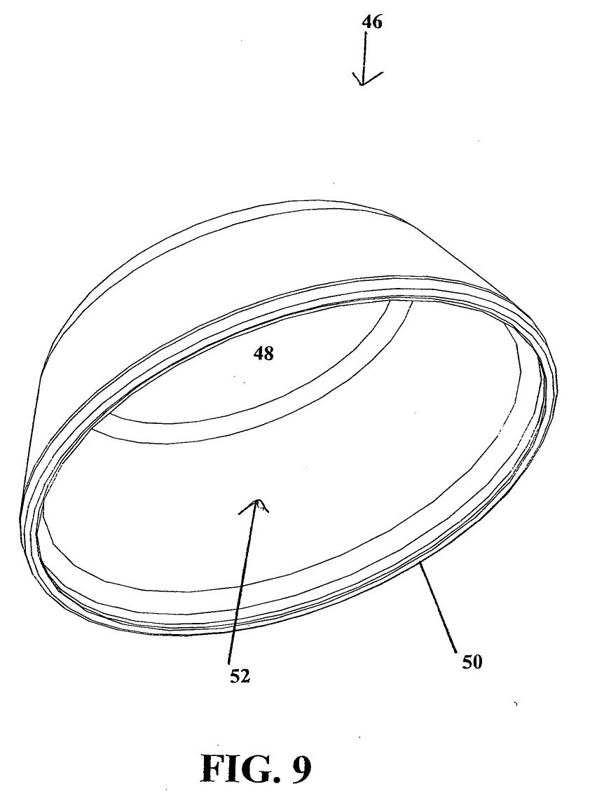

FIG. 10 is a perspective view of the bearing housing of an embodiment of the present invention from a first side thereof.

FIG. 11 is a perspective view of the bearing housing shown in FIG. 10 from a second side thereof.

FIG. 12 is an elevational view of the first side of the bearing housing shown in FIG. 10.

FIG. 13 is an elevational view of the second side of the bearing housing shown in FIG. 11.

FIG. 14 is a plan view of the bearing housing shown in FIG. 10.

FIG. 15 is an end elevational view of a first end of the bearing housing shown in FIG. 10.

FIG. 16 is an end elevational view of a second end of the bearing housing shown in FIG. 10.

FIG. 17 is a perspective view of an assembly of the present invention comprising a side panel with attached bearing housing in an embodiment of the present invention.

FIG. 18 is a perspective view of a side panel as shown in FIG. 17 absent the bearing housing.

FIG. 19 is an end elevational view of the assembly shown in FIG. 17 from a first end thereof.

FIG. 20 is an end elevational view of the assembly shown in FIG. 17 from a second end thereof.

FIG. 21 is a perspective view of an assembly of the present invention comprising a side panel, bearing housing, bearing and shaft in an embodiment of the present invention from a first side thereof.

FIG. 22 is a perspective view of the assembly shown in FIG. 21 from a second side thereof.

FIG. 23 is an elevational view of the assembly shown in FIG. 21 from a first side thereof.

FIG. 24 is an end elevational view of the assembly shown in FIG. 21 from a second side thereof.

FIG. 25 is a plan view of the assembly shown in FIG. 21.

FIG. 26 is an end elevational view of the assembly shown in FIG. 21 from a first end thereof.

FIG. 27 is an end elevational view of the assembly shown in FIG. 21 from a second end thereof.

### DETAILED DESCRIPTION OF PREFERRED EMBODIMENTS

The present invention is embodied in a bearing housing for a conveyor assembly and a bearing assembly system. The bearing housing 20 comprises a device that is capable of being attached to the frame, rail, or panel 60 of the conveyor assembly without fasteners and at the same time, secures a bearing 74 therein without fasteners. As a result, the bearing and its housing are easy to assemble and disassemble and easy to clean, reducing down-time of the assembly and providing a means of maintaining a sanitary system.

While the disclosure herein is particularly described with regard to conveyors and industries where cleaning and sanitary conditions are important, it will be understood and apparent to those of skill in the art that the present invention has other applications where cleanliness or ease of cleaning, assembly and disassembly are important. The bearing housing of the present invention may be used or modified for use with any commercially available bearing or like component, including but not limited to, ball bearings, roller bearings, ball thrust bearings, roller thrust bearings, tapered roller bearings, magnetic bearings, and the like.

Referring to the Figures, the bearing housing 20 of the present invention generally comprises a bearing receptor portion and a panel securing portion.

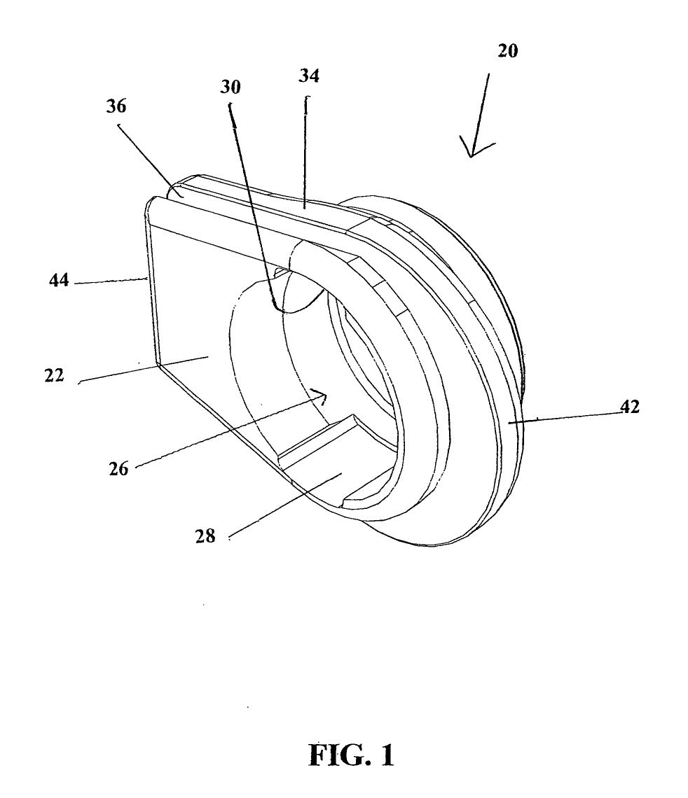

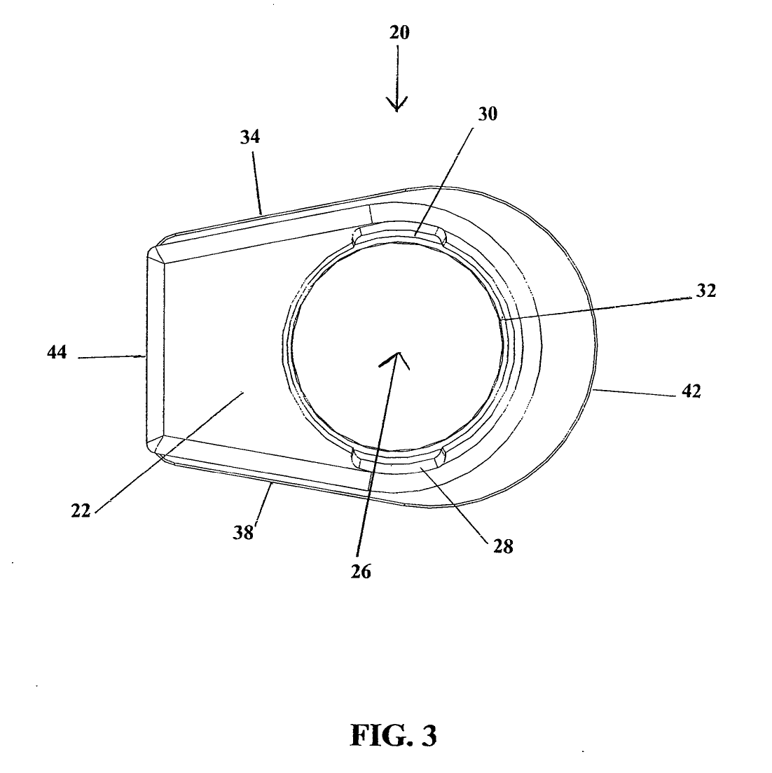

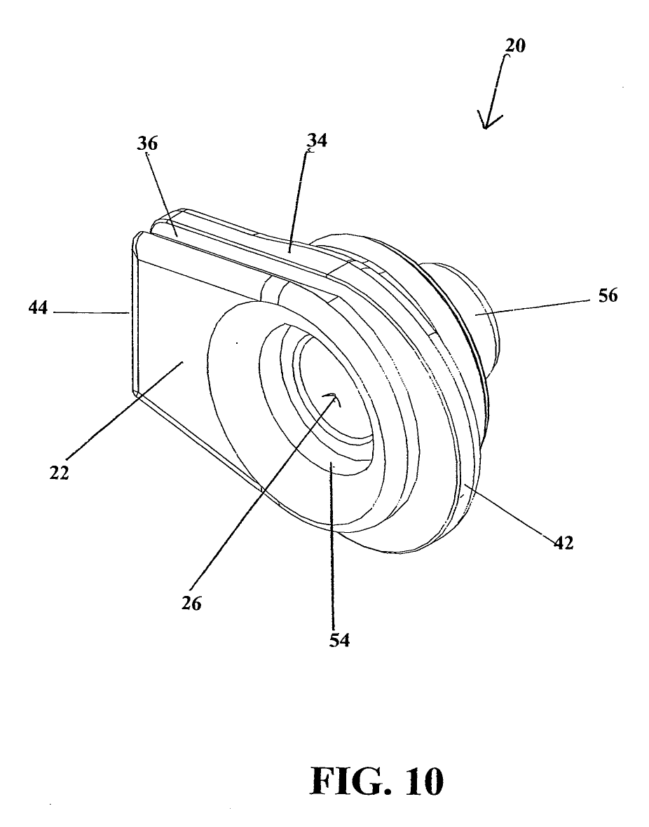

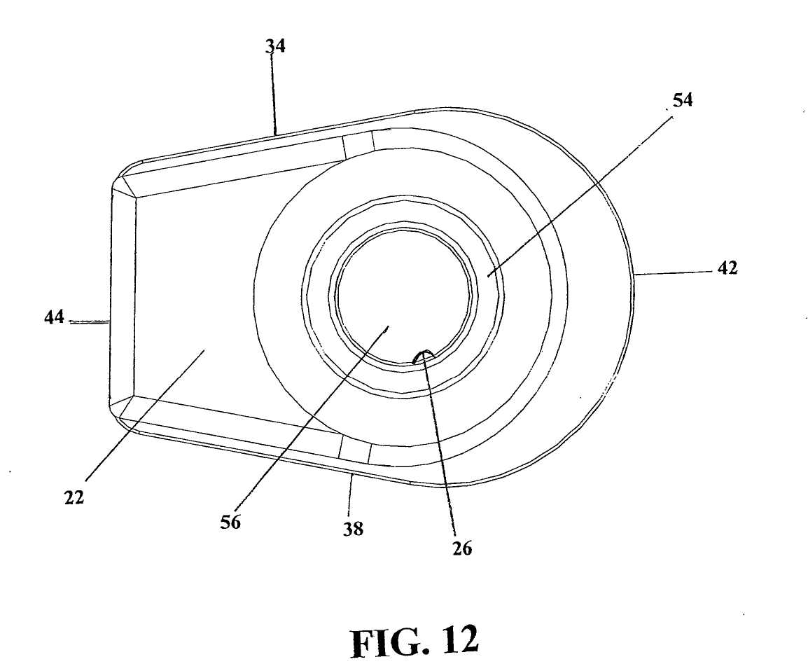

More specifically, the bearing housing 20 comprises a first side 22 and a second side 24. The first side 22 comprises a substantially circular cut-out, or recess 26, within the bearing housing 20. The recess 26 receives a bearing and holds same therein. The recess 26 or bearing receptor portion of the bearing housing 20 in one embodiment, FIGS. 1-3, comprises a first groove 28 and a second groove 30. In a preferred embodiment, the second groove 30 is a mirror image of the first groove 28. The recess 26 may taper inward to a narrower diameter for frictionally engaging and securing a bearing therein, or alternatively may mate with one or more of the grooves 28, 30 via corresponding tongues or protrusions on the bearing. As shown in FIGS. 10 and 12, the recess 26 may be tapered 54 inward from the first side 22 to the second side 24 of bearing housing 20 to provide the frictional engagement with the bearing, securing same in place.

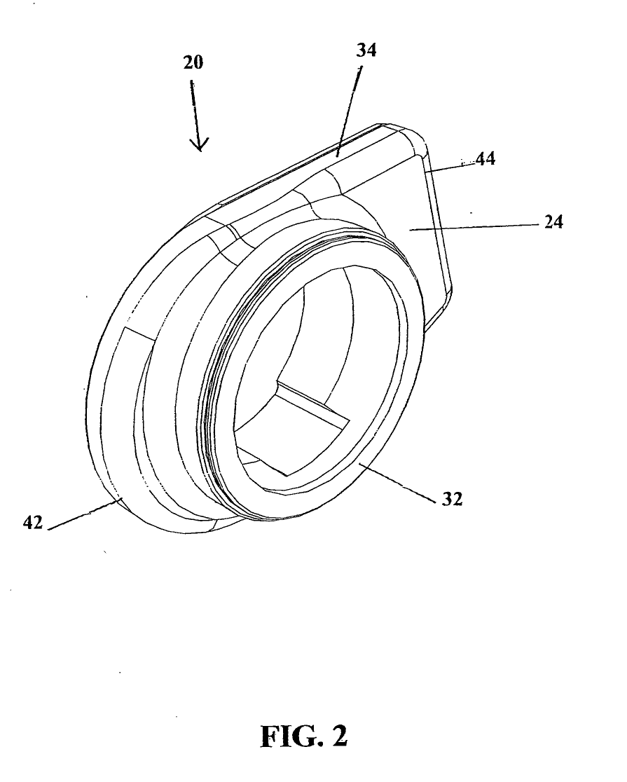

The second side of the bearing receptor portion on the second side 24 of the bearing housing 20 comprises a substantially circular ring 32 at the location of the recess 26 or opening having a slightly narrower diameter opening from that of the recess 26 on the first side 22 of the bearing housing 20 (FIGS. 2 & 4). In the preferred embodiment, the ring 32 provides a “stop” or retention mechanism for retaining the bearing within the housing, preventing the bearing from sliding out or being removed from the second side 24 of the bearing housing 20. Other means of “stopping” the bearing from removal may also be used without departing from the overall scope of the invention, such as a protrusion, a flat surface or other geometrically shaped ring and the like.

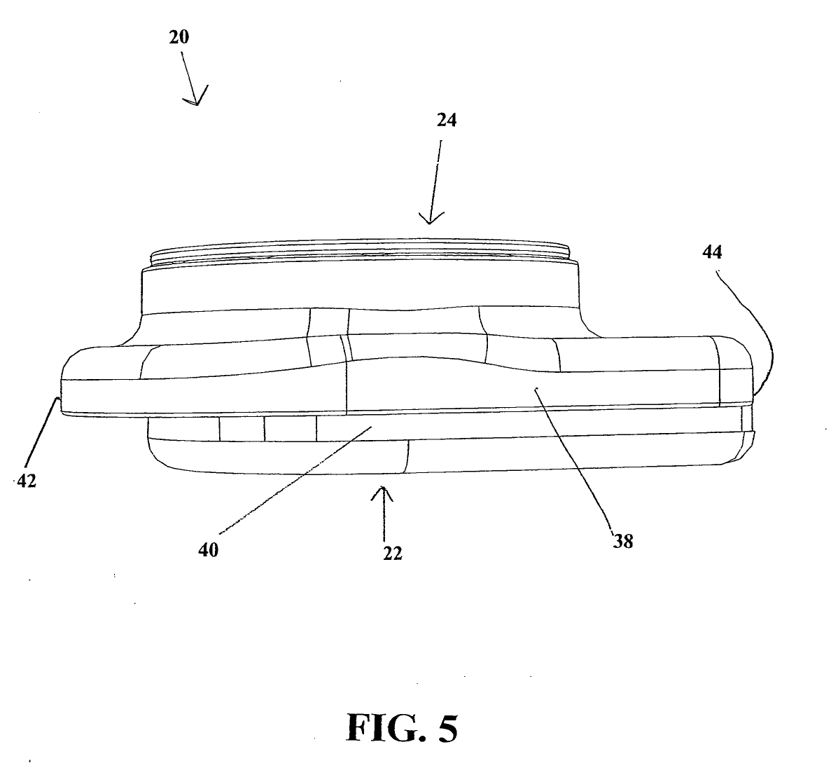

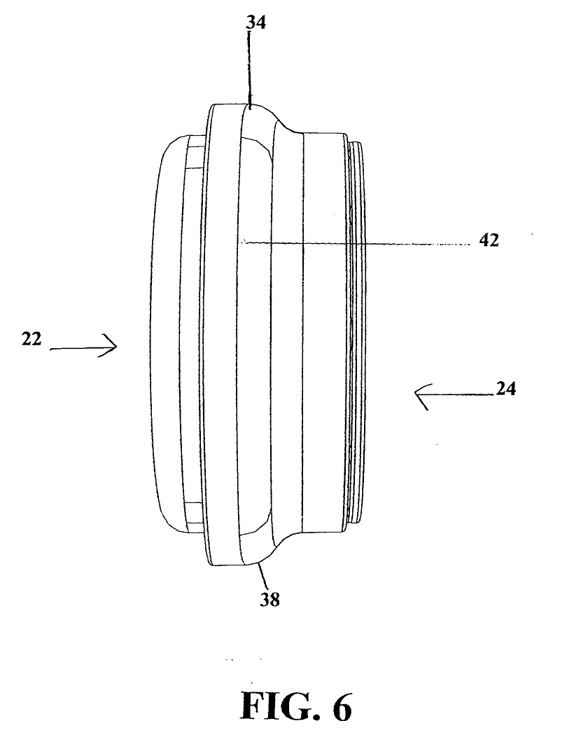

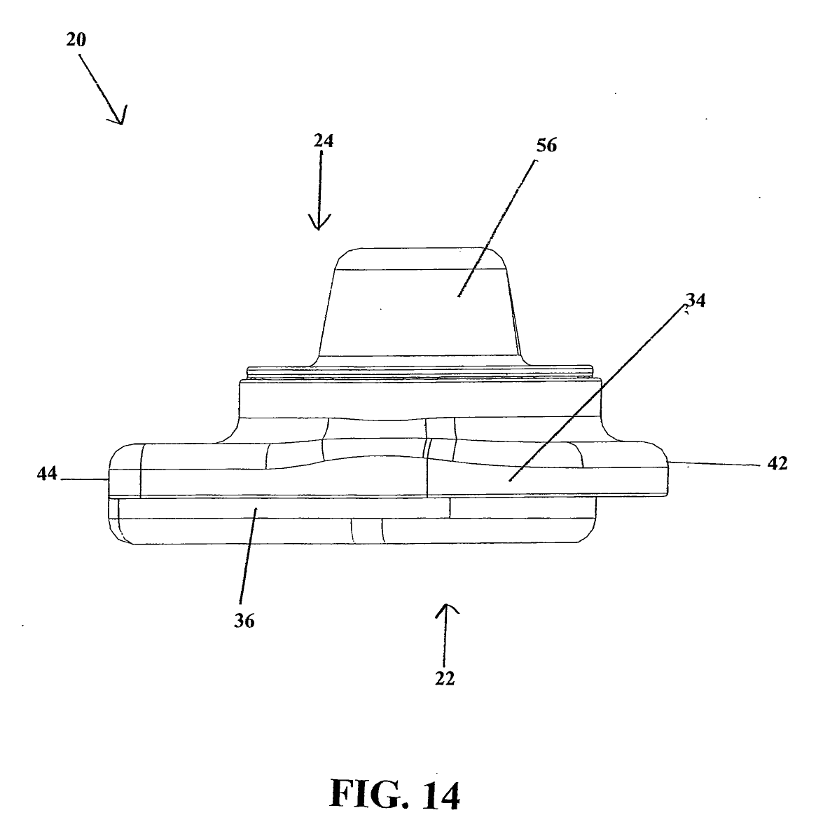

As can be seen in FIGS. 1, 5, 6, 10, 11, 14 & 15, the panel securing portion of the bearing housing 20 comprises first 36 and second 40 grooves or channels on a portion of the bearing housing 20 for receiving a portion of the panel 60 and securing the bearing housing 20 to the panel 60. Preferably, the first 36 and second 40 grooves extend from one end of the bearing housing 20 along a portion of the housing, terminating at an end a distance therefrom. The bearing housing 20 and/or the first 36 and second 40 grooves are preferably tapered, so that the first and second grooves are closer in proximity at one end than the other end of the groove.

In a preferred embodiment, as shown in the Figures, the elements of the bearing housing 20 forming the panel securing portion may comprise: a top or third side 34 of the bearing housing 20, and a bottom or fourth side 38 of the bearing housing 20. The third side 34 of the bearing housing 20 comprises a groove 36 or channel thereon (the “first groove”) extending a distance from the second end 44 of the bearing housing 20 toward the first end 42 of the bearing housing 20, terminating prior to the first end 42. The fourth side 38 of the bearing housing 20, likewise, comprises a groove 40 thereon (the “second groove”) extending from the second end 44 of the bearing housing 20 toward the first end 42, terminating prior to the first end 42. Preferably, the first and second grooves 36, 40 on the terminal end closest to the first end 42 of the bearing housing 20 are further apart than the ends of the first and second grooves located at the second end 44 of the bearing housing 20. As a result of the increasing cross-section or width of the bearing housing 20, the bearing housing, when moved laterally in the opening 62 of the panel 60 for assembly (discussed in further detail herein below), forms a tight frictional engagement between the panel 60 and the bearing housing 20 as a result of the engagement or interaction between the grooves 36, 40 and the panel 60, thereby preventing movement of the bearing housing 20, and securing same in position without fasteners.

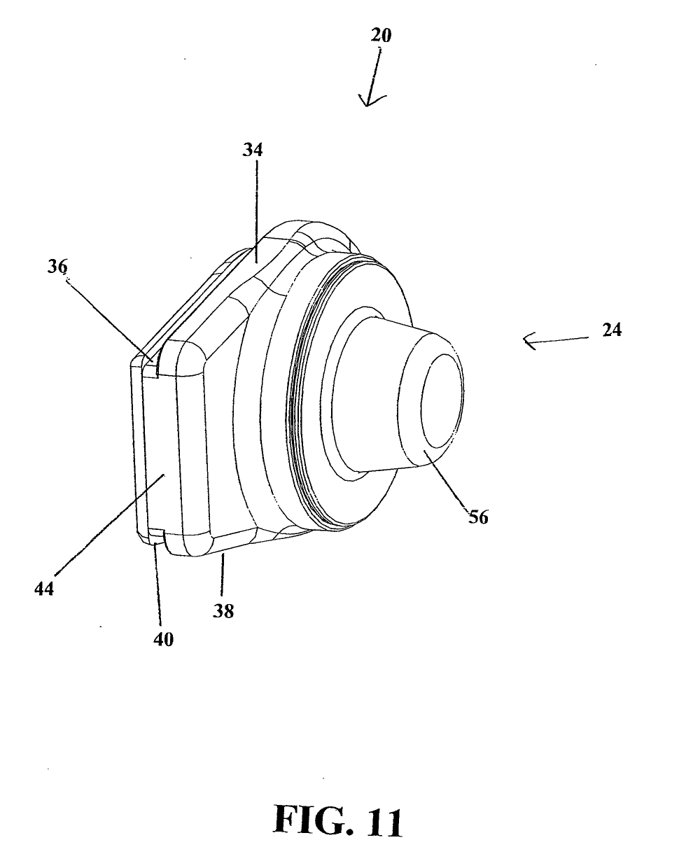

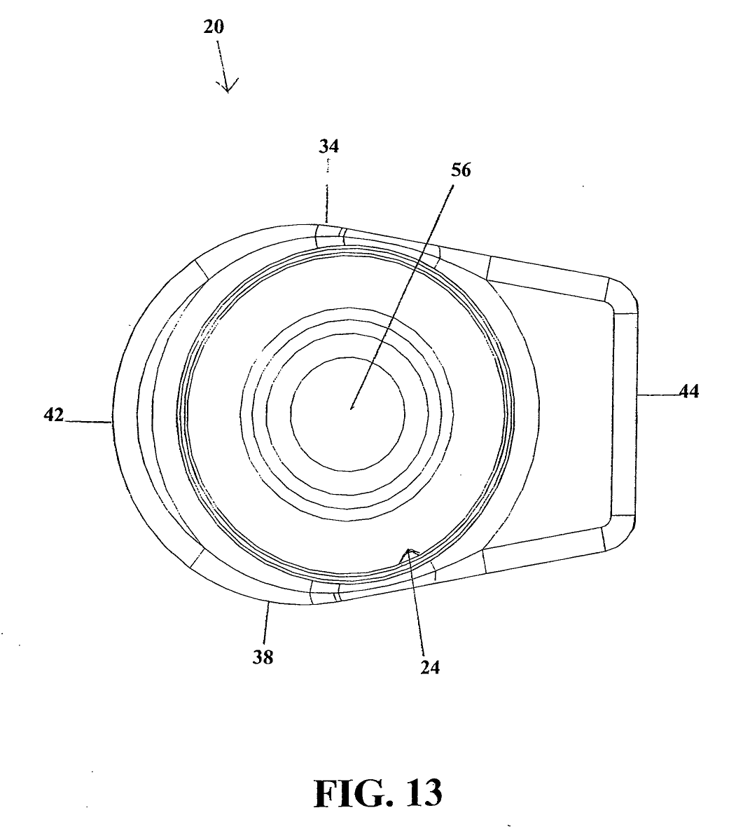

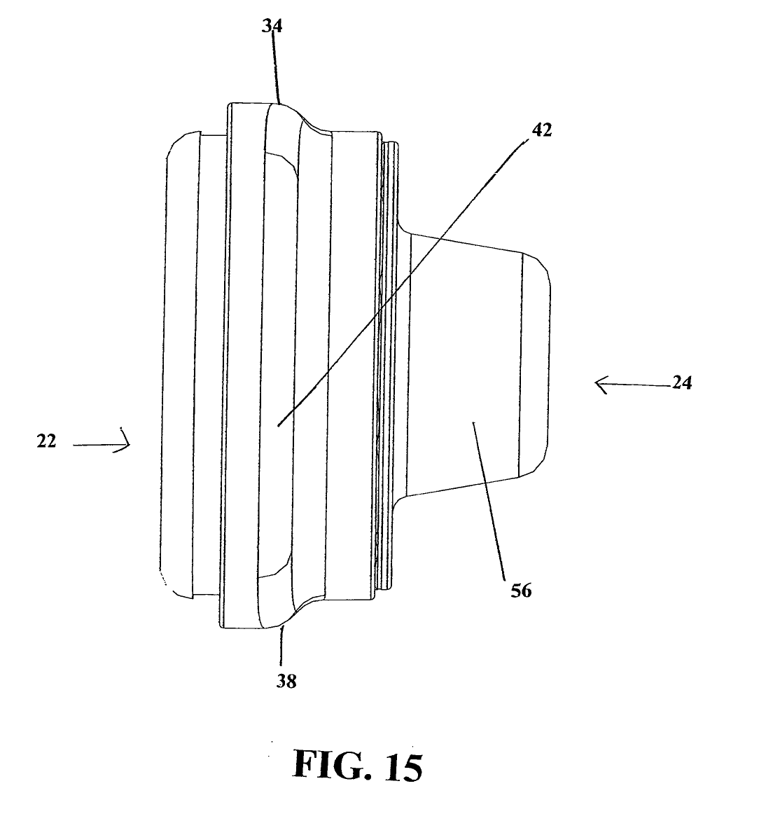

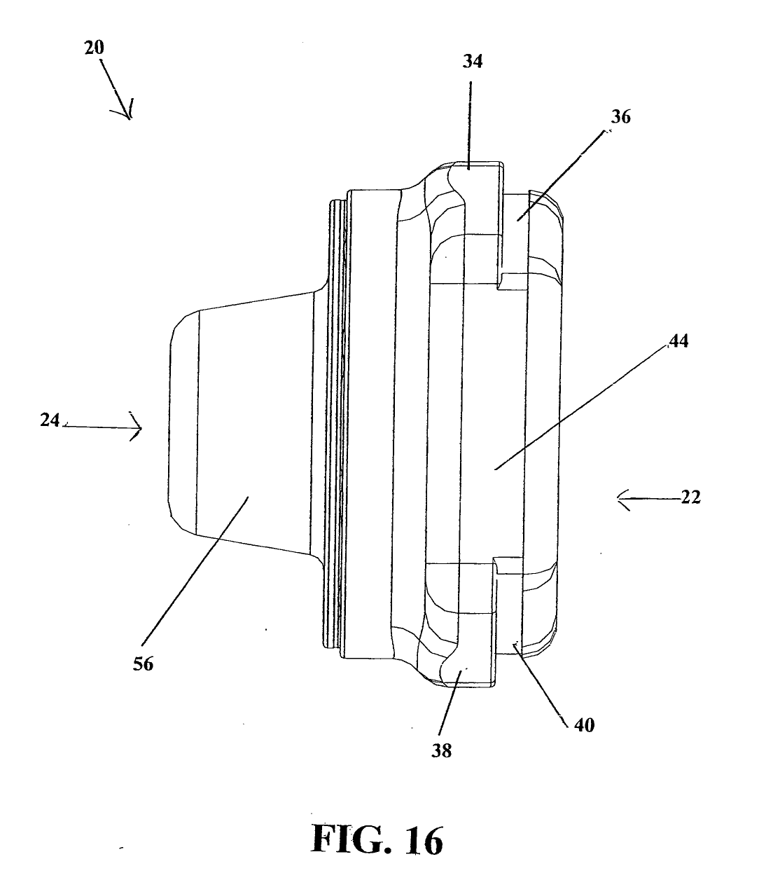

In an alternative embodiment, as shown in FIGS. 10-16, the second side 24 of the bearing housing 20 comprises substantially a solid surface covering 56, that covers a substantial position of or all of the opening 62 formed by the recess 26. This covering 56 comprises an outwardly extending, inwardly tapered or narrowing diameter enclosed cylinder. Other shaped enclosures are also contemplated herein, such as, but not limited to, a spherical enclosure, an enclosure having one or more flat surfaces, and a cylindrical enclosure that does not change diameter, or increase in diameter. The ring 32 may or may not be provided thereon. As can be seen in FIGS. 11 and 13-16, the enclosed cylinder 56 is integrally attached on a second side 24 of the bearing housing 20, preferably, at a location corresponding to the location of the recess 26. As a result, the enclosed cylinder 56 forms an integrally attached cap or cover for the bearing receptor portion, on a second side 24 thereof. In a preferred embodiment, a shaft, tapered bearing or the like may be received within the area 54 defined by the enclosed cylinder (See FIG. 12). In other words, the recess 26 is in integral communication with the area defined by the enclosed cylinder 56. The cylinder may prevent debris, waste, and/or damage to the bearing assembly by enclosing the bearing assembly within the housing. Moreover, the enclosed cylinder 56 may prevent the bearing or other attached components from being removed or sliding out from the second side 24 of the bearing housing 20.

In the preferred embodiment, the bearing housing 20 comprises a single component that is molded, such as by injection molding, from the relevant materials into the configuration shown in the Figures. The materials used may be plastic, stainless steel, aluminum, and other like components which are easy to clean, easy to manufacture, and not corrosive.

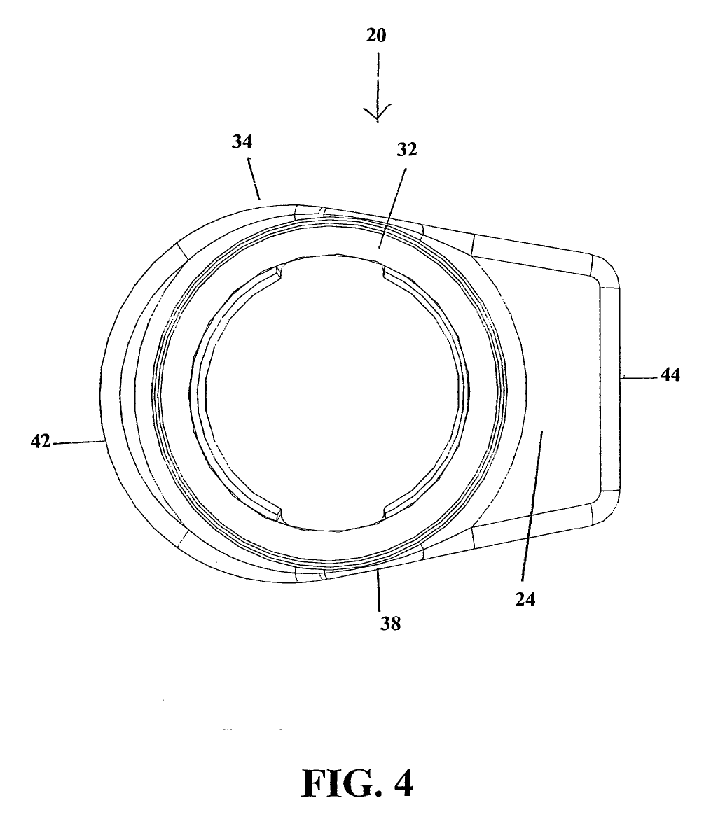

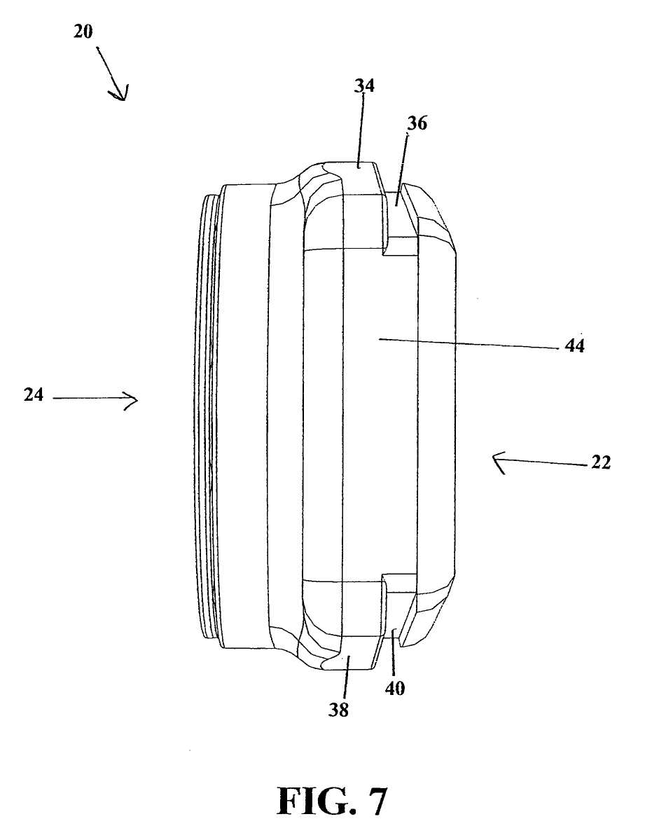

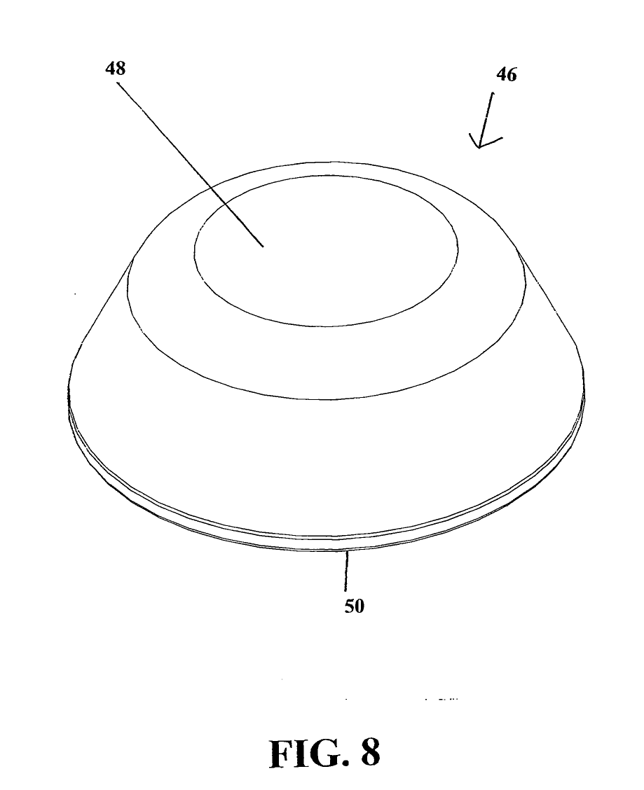

While the enclosed cylinder may be integrally attached, in one embodiment, a cap 46 (see FIGS. 8 & 9) may be provided for attachment on the second side 24 of the bearing housing 20 shown in FIGS. 1-7. As with the integrally attached cylinder, the cap 46 covers at least a portion of the bearing and corresponding attachments. Thus, the cap 46 may be used to maintain the bearing in a sanitary condition, free from debris and other contaminants and/or damage. Referring to FIGS. 8 & 9, the cap 46 comprises a tapered, covered cylinder or partial, conical-shaped component 52, but may be shaped in any form as previously described with respect to the integrally attached cylinder 56. The cap 46 may comprise material similar to that used to manufacture the bearing housing 20. In a preferred embodiment, the cap 46 attaches to the second side 24 of the bearing housing 20. The cap 46 preferably comprises an enclosed top 48 and a connection point 50 for connecting the housing. The cap 46 may be connected to the bearing housing 20 by any means known in the art, including friction fit, tongue and groove, fastening means, welding and the like. Moreover, the cap 46 may be permanently attached or removable.

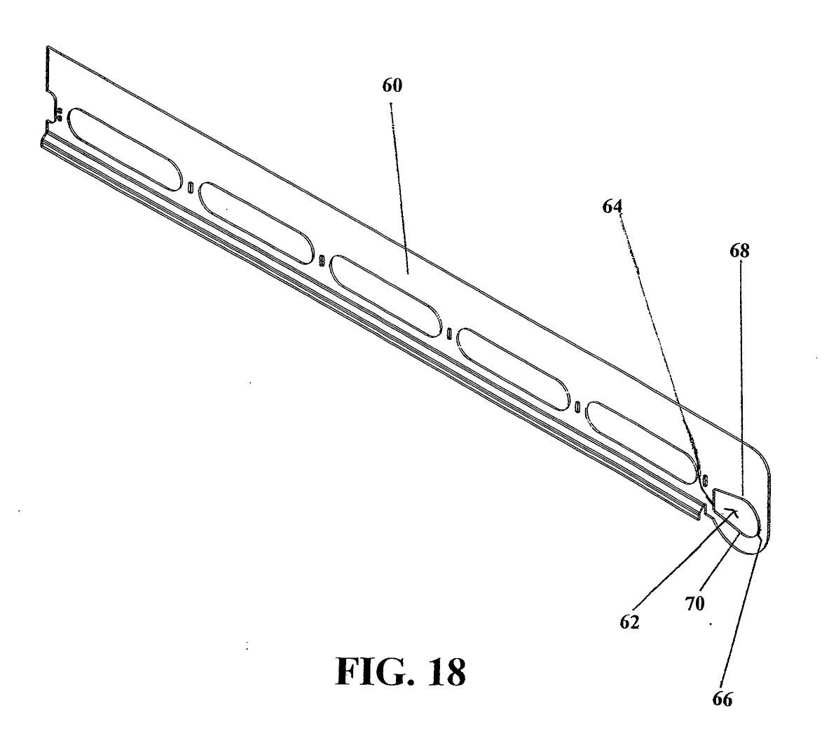

Referring to the assembly 58 of the present invention, in a preferred embodiment, the bearing housing 20 is removably attached or secured to a panel 60, such as a side panel of a conveyor assembly, for the support of a bearing therein. As can be seen in FIG. 18, the side panel 60 comprises a cut-out or opening 62 that substantially corresponds in shape to the bearing housing 20. Specifically, the opening 62 is tapered at one end to correspond to the grooves 36, 40 of the bearing housing 20 which is inserted therein. In the preferred embodiment, the opening 62 is larger than the bearing housing 20 at one end. As a result, the bearing housing 20 may be inserted into this opening 62 and slid or moved laterally toward the narrower tapered portion of the opening to secure the bearing housing 20 in place on the side panel 60 via a frictional engagement. To remove the bearing housing 20, the housing is slid or moved laterally in the opposite direction.

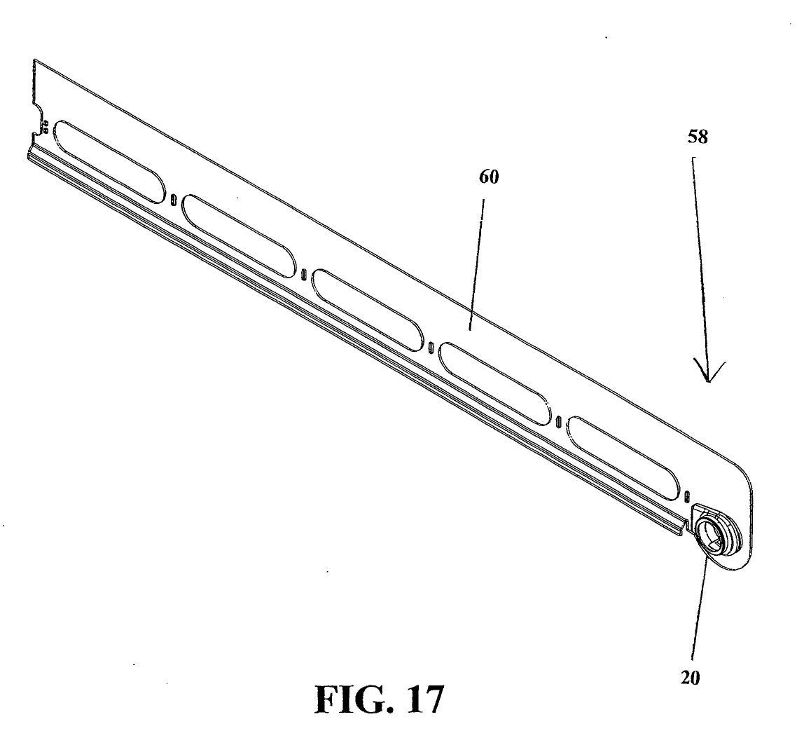

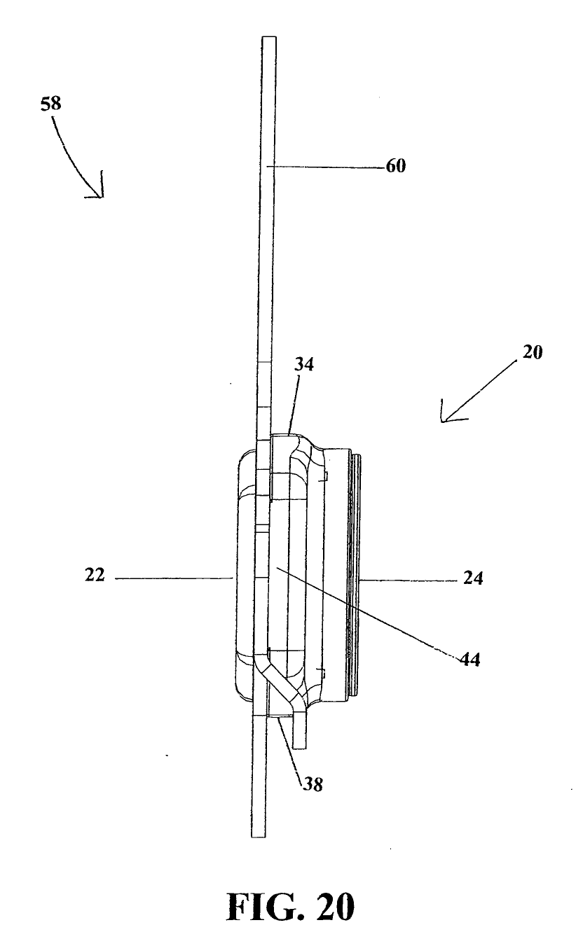

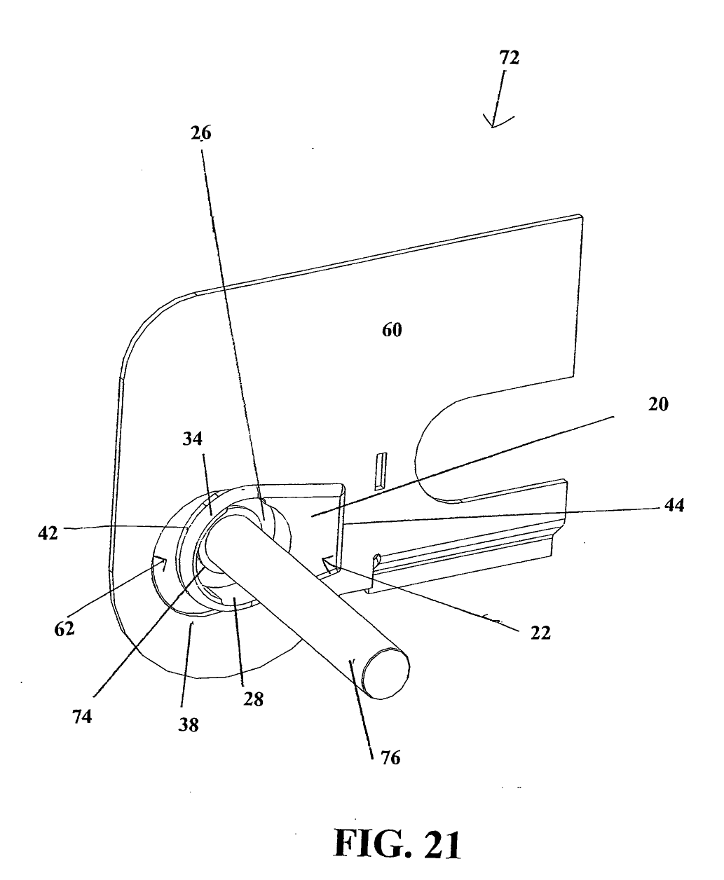

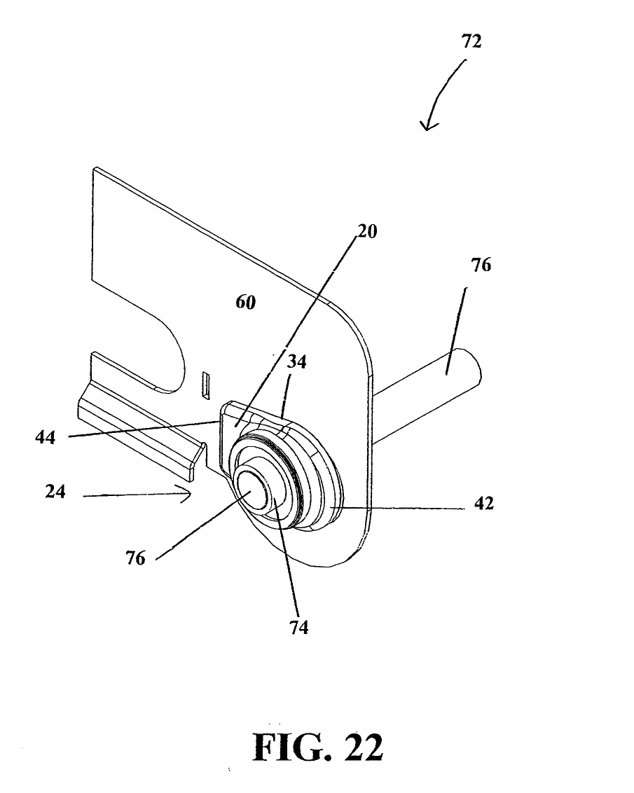

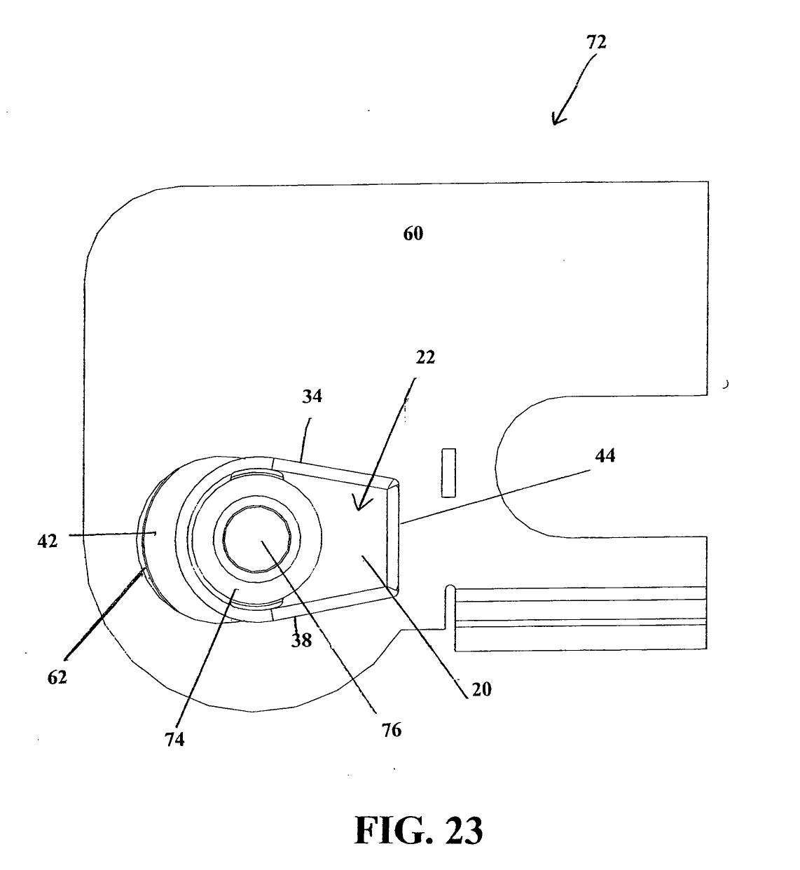

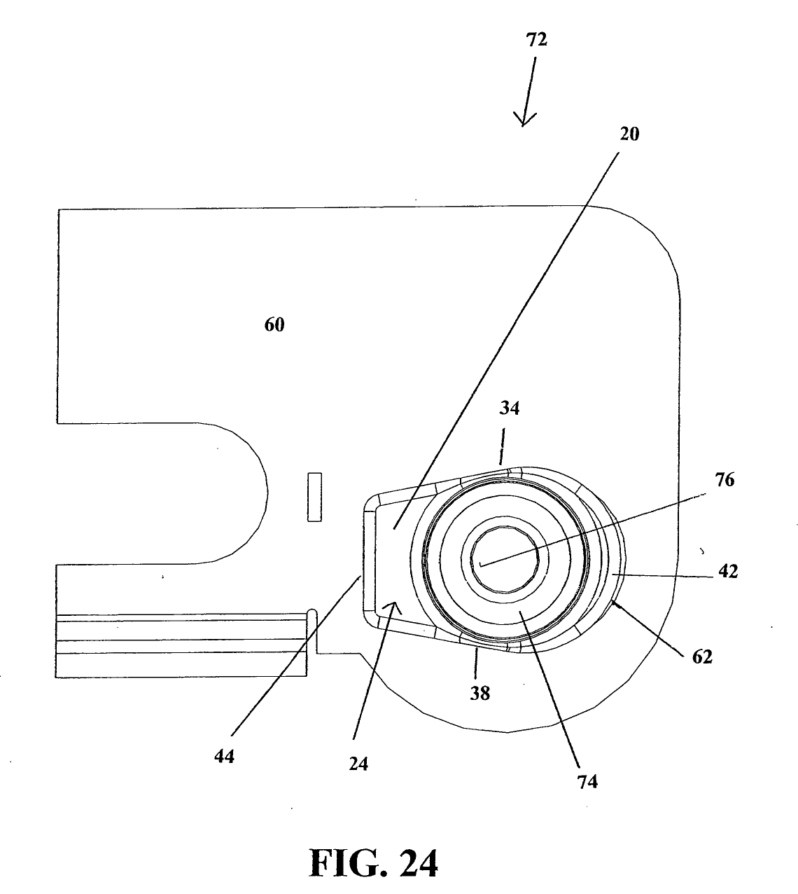

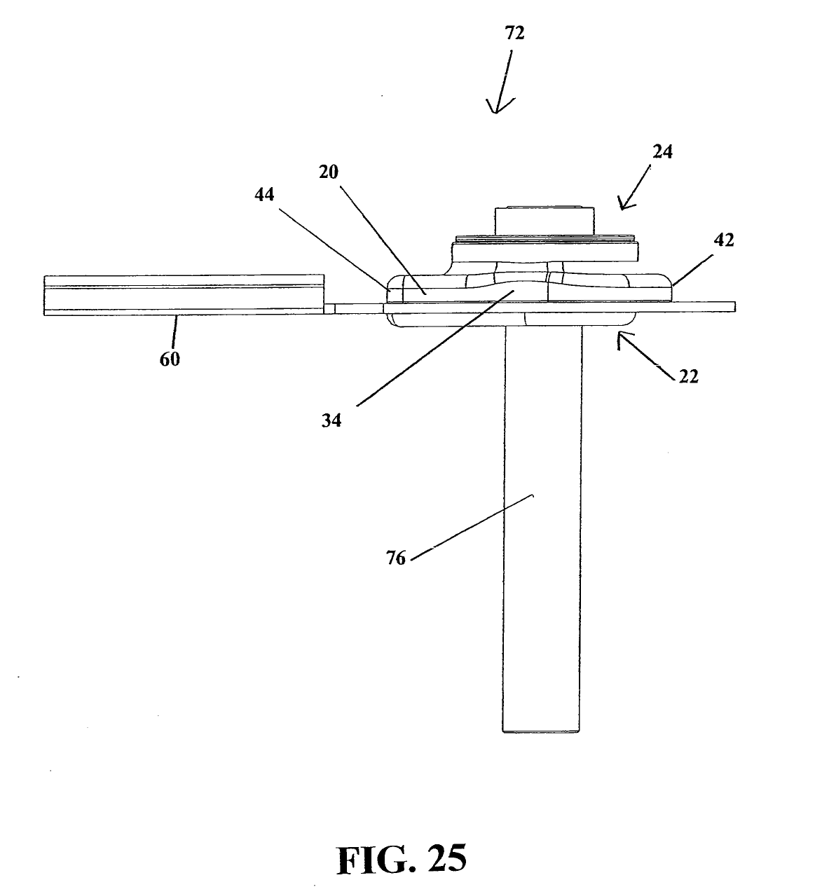

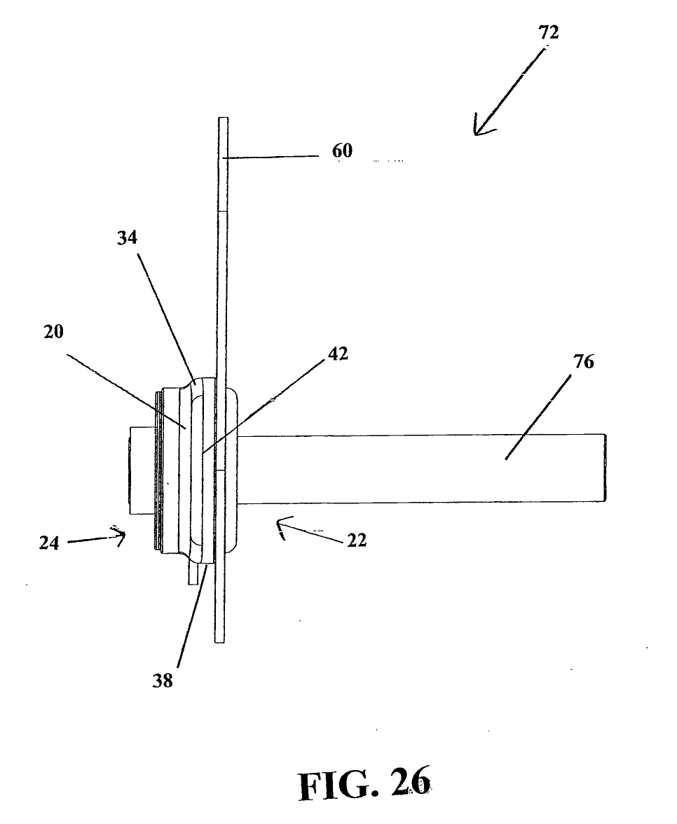

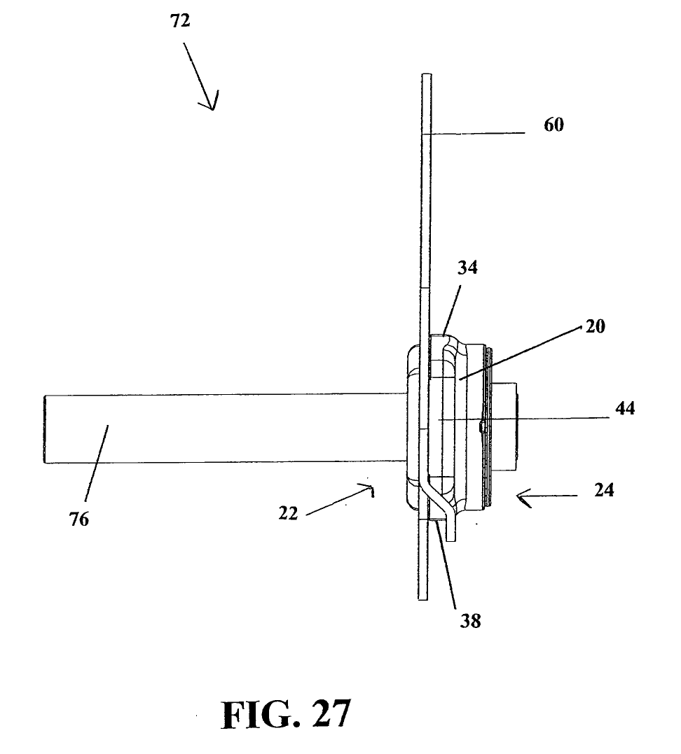

In a preferred embodiment, as shown in FIGS. 17-27, the opening 62 on the panel 60 comprises a first end 66, a second end 64, a first side 68 or top and a second side 70 or bottom. When the bearing housing 20 is inserted into the opening 62, the orientation of the bearing housing is arranged so that the first side 42 of the bearing housing is located in proximity to the first end 66 of the opening 62, the second side 44 of the bearing housing is located in proximity to the second end 64 of the bearing housing, the third side 34 of the bearing housing is located in proximity to the first side 68 of the opening 62, and the fourth side 38 of the bearing housing is located in proximity to the second side 70 of the opening 62. Once the bearing housing 20 is positioned as described hereinabove, the bearing housing 20 is moved laterally toward the second end 64, as shown in the Figures, so that the bearing housing 20 engages the panel 60 at the opening 62, and preferably is frictionally engaged so as to retain the bearing housing in position in the opening 62. In detail, once the bearing housing 20 is repositioned or moved laterally, the bearing housing 20 is in contact with at least a portion of the panel 60 at the opening 62. Preferably, the first 36 and second 40 grooves of the bearing housing are in contact with, and engage the first 68 and second 70 sides of the opening 62, respectively. The second end 64 of the opening 62 may also be in contact with the second side 44 of the bearing housing, although such contact is not required. By moving the bearing housing 20 laterally to secure the housing in position on the panel 60, the first side 42 of the bearing housing is moved a distance away from the first end 66, resulting in a small space there between (see, e.g., FIG. 21).

Referring to FIGS. 21-27, an assembly 72 is provided comprising a bearing housing 20 having a bearing 74 and shaft 76 attached thereto. As can be seen, the bearing housing 20 is inserted into the side panel 60 of the conveyor assembly and moved laterally into position as described hereinabove, thus, creating a small space between the bearing housing 20 and the panel 60. The bearing 74 is inserted into the recess 26. The inner ring 32 of the bearing housing 20 and the shape of the recess 26 and/or grooves 28, 30 retain the bearing 74 in position, preventing same from sliding out of the bearing housing 20 as described herein. A shaft 76 or other rotatable component is connected with or placed in operable contact with the bearing 74. Accordingly, as can be seen, a portion of the shaft 76 is positioned within the bearing 74 on the bearing receptor side of the bearing housing 20 (along with the bearing or relevant insert) and is retained in position within the bearing housing 20. The shaft 76 may then support the relevant rotating components of the conveyor assembly.

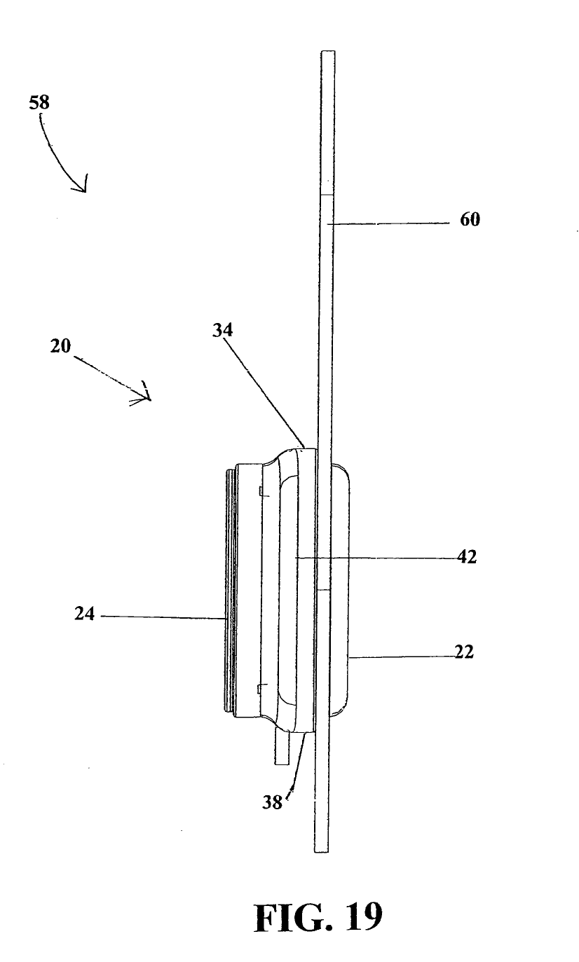

A method of assembling a bearing 74 on a conveyor assembly 72 is also provided. The method comprises providing at least one side panel 60 or rail having an opening 62 thereon for receiving a bearing housing 20. A bearing housing 20 is also provided as set forth hereinabove. In a preferred embodiment the bearing housing 20 is inserted into the opening 62 so that a portion of the bearing housing 20 extends out away from a first side of the side panel 60 and a portion of the bearing housing 20 extends out away from the second side of the side panel 60 (see FIGS. 19-20, 26-27). More specifically, a first portion 68 of the opening 62 is received in a first groove 36 of the bearing housing 20 and a second portion 70 of the opening 62 is received in a second groove 40 of the bearing housing 20. Once the first groove 36 and second groove 40 of the bearing housing 20 are aligned with the first portion 68 and second portion 70 of the opening 62, the bearing housing 20 is moved laterally to mate and form a tight fit or frictional engagement between the grooves 36, 40 and the portions 68, 70 of the opening 62, thereby securing the bearing housing 20 within the side panel 60.

A bearing 74 is inserted into the recess 26 in the first side 22 of the bearing housing 20, either before or after the housing is attached to the side panel 60. The bearing 74 is slid into the recess 26 and secured via a friction fit or via corresponding grooves 28, 30 on the recess 26 of the bearing housing 20 that mate with corresponding engagement devices on the bearing (not shown). Other attachment mechanisms are also contemplated by the present invention. The bearing 74 may then receive a shaft 76 or other like component for rotational movement in connection with the assembly 72.

The bearing 74 and the bearing housing 20 can be subsequently removed by applying pressure in the opposite direction to release the frictional engagement of the respective components.

In this manner, the bearing housing and bearing assembly can be easily assembled and disassembled, reducing down time of the machine and allowing for easy cleaning and fewer locations for buildup or other waste to form or collect.

The various mechanisms for the bearing housing, assembly, and method disclosed herein may be combined in numerous combinations, and the invention should not be limited to the particular combinations described and illustrated herein.

Presently preferred embodiments of the present invention and many of its improvements have been described with a degree of particularity. The previous description is of preferred examples for implementing the invention, and the scope of the invention should not necessarily be limited by this description.

We claim:

1. A bearing housing for removably securing a bearing comprising:
a first side having a recess for receiving a bearing;
a second side having a bearing retaining means for preventing removal of the bearing from the second side; and
means for retaining the bearing housing within an opening without fasteners.

2. The bearing housing of claim 1, wherein the bearing retaining means comprises an integrally connected ring with a diameter smaller than the diameter of the recess.

3. The bearing housing of claim 2, further comprising a cap removably secured to the second side of the bearing housing.

4. The bearing housing of claim 1, wherein the bearing retaining means comprises an enclosure.

5. The bearing housing of claim 1, wherein the recess comprises at least one groove.

6. The bearing housing of claim 1, wherein the recess is inwardly tapered to narrow in diameter from the first side of the bearing housing to the second side.

7. The bearing housing of claim 1, wherein the means for retaining the bearing housing comprises:
a first groove on a third side of the bearing housing capable of engaging at least a portion of a panel forming the opening;
a second groove on a fourth side of the bearing housing capable of engaging at least a portion of a panel forming the opening simultaneously with the engagement of the third side.

8. The bearing housing of claim 7, wherein the bearing housing tapered to be frictionally secured within the opening.

9. The bearing housing of claim 1, wherein the bearing housing comprises a single molded component.

10. The bearing housing of claim 9, wherein the bearing housing comprises a material selected from the group consisting of plastic and metal.

11. The bearing housing of claim 1, further comprising a removably secured attachment of the bearing housing to a conveyor assembly.

12. A bearing assembly comprising;
a panel having an opening;
a bearing housing removably secured to the panel without fasteners; and
a bearing removably secured to the bearing housing without fasteners.

13. The bearing assembly of claim 12, further comprising a rotatable component attached to the bearing.

14. The bearing assembly of claim 12, further comprising a cap removably attached to the bearing housing.

15. The bearing assembly of claim 12, wherein the panel comprises a side panel of a conveyor assembly.

16. The bearing assembly of claim 12, wherein the rotatable component comprises a shaft.

17. The bearing assembly of claim 12, wherein the bearing assembly is operably attached to a conveyor assembly.

18. A method of assembling a bearing assembly comprising:
providing a panel having an opening;
inserting a bearing housing into the opening of the panel;
engaging at least a portion of the bearing housing with at least a portion of the panel at the opening, securing the bearing housing in place on the panel without fasteners;
inserting a bearing into the bearing housing and securing the bearing to the bearing housing without fasteners; and
attaching a rotatable component to the bearing.

19. The method of claim 18, wherein the panel is secured to a conveyor assembly.

20. The method of claim 18, wherein the engagement of at least a portion of the bearing housing with at least a portion of the opening comprises laterally repositioning the bearing housing within the opening in a narrowing portion of the opening, thereby providing a frictional engagement between the bearing housing and the opening.
